(19) United States
(12) Patent Application Publication
(10) Pub. No.: US 2024/0113936 A1
(43) Pub. Date: Apr. 4, 2024

(54) METHOD AND SYSTEM FOR ARTIFICIAL INTELLIGENCE-BASED ACCELERATION OF ZERO-TOUCH PROCESSING

(71) Applicant: Genpact Luxembourg S.à r.l. II, Luxembourgh (LU)

(72) Inventors: Vivek Saxena, Gurgaon (IN); Kathryn Stein, New York, NY (US); Vikram Jha, Sealdah (IN); Lavi Sharma, Gurgaon (IN)

(21) Appl. No.: 17/935,681

(22) Filed: Sep. 27, 2022

(51) Int. Cl. H04L 41/0806; H04L 67/12

(52) U.S. Cl. CPC H04L 41/0806; H04L 67/12

(57) ABSTRACT

Zero-touch monitoring devices and systems are disclosed that are configured with hardware to perform a process-mining on an event-to-entry process associated with an organization to collect data information associated with the process, determine an input-related zero-touch quotient for the event-to-entry process based on the data information, determine a rule-related zero-touch quotient for the event-to-entry process based on the data information, determine a zero-touch potential predictive accounting factor (ZTP PAF) value for the event-to-entry process, and generate a zero-touch processing quotient for the event-to-entry process based on the input-related zero-touch quotient, the rule-related zero-touch quotient, and the ZTP PAF value. The ZTP PAF value quantifies an incremental zero-touch potential for the event-to-entry process and corresponding attributes.

### TECHNICAL FIELD

The disclosure generally relates to the field of process automation and, more particularly, to methods and systems for an artificial intelligence-based acceleration of zero-touch processing in process automation.

### BACKGROUND

With the technologies enabling automation having been getting more mature and capable with respect to cognitive automation and their predictive effectiveness, operational processes (e.g., accounting and other businesses processes) in various fields are increasingly being automated, and human interventions (also referred to as touchpoints) are gradually being eliminated, especially after the unprecedented impact of the COVID 19 pandemic. For instance, zero-touch sales have driven a surge of products being sold through websites by minimizing the sales touchpoint upfront in the sales cycle. Similarly, zero-touch interfaces have been transitioning people out of the world of typing, clicking, dialing, swiping, etc., by incorporating new features such as facial recognition, voice commands, augmented reality, and virtual reality. In terms of the manufacturing field, zero-touch products are adapting to a lighter-touch version after the pandemic passes to stay relevant. For instance, zero-touch products are shifting the provisioning, installation, deployment, and configuration complexity out of the packaged product and into the customer's technology ecosystem, where automatic deployment solutions enable people to get software up and running with little to no configurations to manage, so a well-documented process, clear APIs and packaging become paramount.

While zero-touch related technologies have been actively explored by a large variety of industrial, informational technology, and manufacturing fields, the implementation of zero-touch processing in operational processing is really limited. For example, zero-touch processing to limit human intervention in business operations (e.g., in the accounting universe) falls behind most other fields. One of the main reasons that the zero-touch related technologies are limited in the operational processing is the lack of effective tools for monitoring the progress of automation in operational processing. For example, when exploring the zero-touch-related technologies, without a proper evaluation tool, many organizations find it difficult to develop an effective strategy to reduce human interventions, since the organizations may have no idea how far they are from achieving their zero-touch potential (e.g., a situation where there is minimal human intervention in view of the current automation technologies). In addition, without a proper evaluation tool, it may become unclear what specific automation technologies should be further developed to address current strains that prevent further improvements in human intervention reduction in operational processing.

Therefore, there is a need for an effective zero-touch potential monitoring tool that can provide an accurate assessment of the zero-touch potential for operational processes to accelerate zero-touch processing in the relevant fields.

### SUMMARY

To address the aforementioned shortcomings, a system and method for driving zero-touch potential for an event-to-entry process are provided. The method includes performing process-mining for an event-to-entry process associated with an organization to collect data information associated with the process, determining an input-related zero-touch quotient for the event-to-entry process based on the data information, determining a rule-related zero-touch quotient for the event-to-entry process based on the data information, determining a zero-touch potential predictive accounting factor (ZTP PAF) value for the event-to-entry process, and generating a zero-touch processing quotient for the event-to-entry process based on the input-related zero-touch quotient, the rule-related zero-touch quotient, and the ZTP PAF value. The ZTP PAF value quantifies an incremental zero-touch potential for the event-to-entry process and corresponding attributes.

The foregoing is a summary and thus contains, by necessity, simplifications, generalizations and omissions of detail; consequently, the summary is illustrative only and is not limiting in any way. Other aspects, inventive features, and advantages of the systems and/or processes described herein will become apparent in the non-limiting detailed description set forth herein.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIGS. 1A-1C illustrate block diagrams of exemplary event-to-entry processes, according to some embodiments.

FIG. 2 illustrates an exemplary event-to-entry evaluation and monitoring system, according to some embodiments.

FIG. 3 illustrates an exemplary operation of an input-related zero-touch evaluation engine, according to some embodiments.

FIGS. 4A-4C illustrate exemplary maturity levels of different data components for measuring an input-related zero-touch quotient, according to some embodiments.

FIG. 5 illustrates an exemplary operation of a rule-related zero-touch evaluation engine, according to some embodiments.

FIGS. 6A-6C illustrate exemplary maturity levels for different data components for measuring a rule-related zero-touch quotient, according to some embodiments.

FIG. 7 illustrates an example process flow for determining a zero-touch potential predictive accounting factor (ZTP PAF) value for an event-to-entry process using a machine learning model, according to some embodiments.

FIG. 8 illustrates a flow chart of an exemplary method for determining a zero-touch processing quotient for an event-to-entry process, according to some embodiments.

### DETAILED DESCRIPTION

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the spirit and scope of the present disclosure. It is also to be understood that features of the various embodiments and examples herein can be combined, exchanged, or removed without departing from the spirit and scope of the present disclosure.

In accordance with various embodiments, the methods and systems described herein provide effective technical solutions that allow to actively monitor and/or accelerate automation of operational processes or components involved in such processes, to address technical problems in the existing operational processes automation field. The methods and systems disclosed herein treat an operational process as including one or more event-to-entry cycles (the operational process is also referred to as an event-to-entry process), which contain a repeatable pattern-related sequence of activities or events. The methods and systems disclosed herein then implement a process-mining process to extract data and other information related to the process. The methods and systems disclosed herein further evaluate the extent of human intervention to which the operational process is performed along the sequence of activities or events. The methods and systems disclosed herein may leverage a machine learning-based predictive model framework to determine the extent of human intervention to which the process is performed, and to increase the entitlement of zero-touch processing based on the insights obtained therefrom. The methods and systems disclosed herein, therefore, move the zero-touch processing of an operational process (or event-to-entry process) as close to zero as possible through consistent assessment of human intervention and feedback-based controlling of human intervention in the process.

From the above descriptions and further descriptions below, the technical solutions disclosed herein show technical improvements when compared to other existing operational processes monitoring tools. First, the methods and systems disclosed herein evaluate the event-to-entry processes from the angle of data science and process management that support the analysis of the operational processes based on the event log data. That is, the methods and systems utilize event log data to determine what operational processes are being performed, and thus allow to explore of the data science tools fueled by the availability of event log data, which then provides more accurate and objective evaluation and/or monitoring of the operational processes. Second, the methods and systems disclosed herein explore artificial intelligence by using machine learning models to evaluate the extent of human intervention from different angles-of-view. The machine learning models, once trained, can provide accurate and qualitative or quantitative measurements of the human intervention in the event-to-entry processes. For example, through machine learning-based qualitative and quantitative monitoring of different segments involved in event-to-entry processes, the whole operational process can be effectively monitored, which then allows to assess or fix accountability for human intervention-involved events (also referred to as touchpoints) based on generated insights, and further improves the operational processes based on the assessment. In addition, through the inclusion of the machine learning-based predictive accounting factor in monitoring the event-to-entry processes, the solutions disclosed herein can accurately determine how far the current event-to-entry processes are from achieving zero-touch potential (e.g., a process with minimal or no human intervention). This then provides guidelines for reducing human intervention in the event-to-entry processes, resulting in the improved performance of the processes monitoring tools or systems.

It is to be understood that the benefits and advantages described herein are not all-inclusive, and many additional features and advantages will be apparent to one of ordinary skill in the art in view of the figures and the following descriptions.

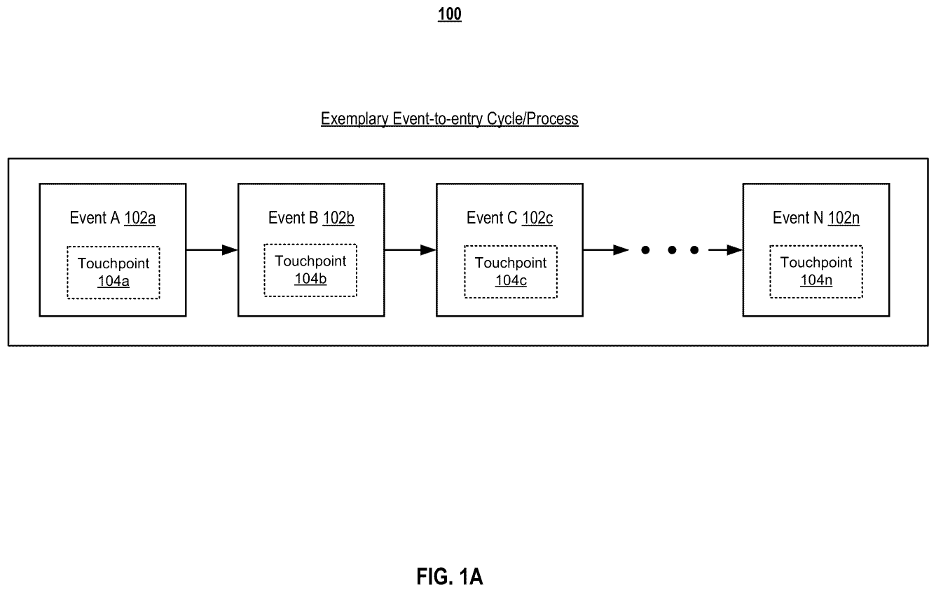

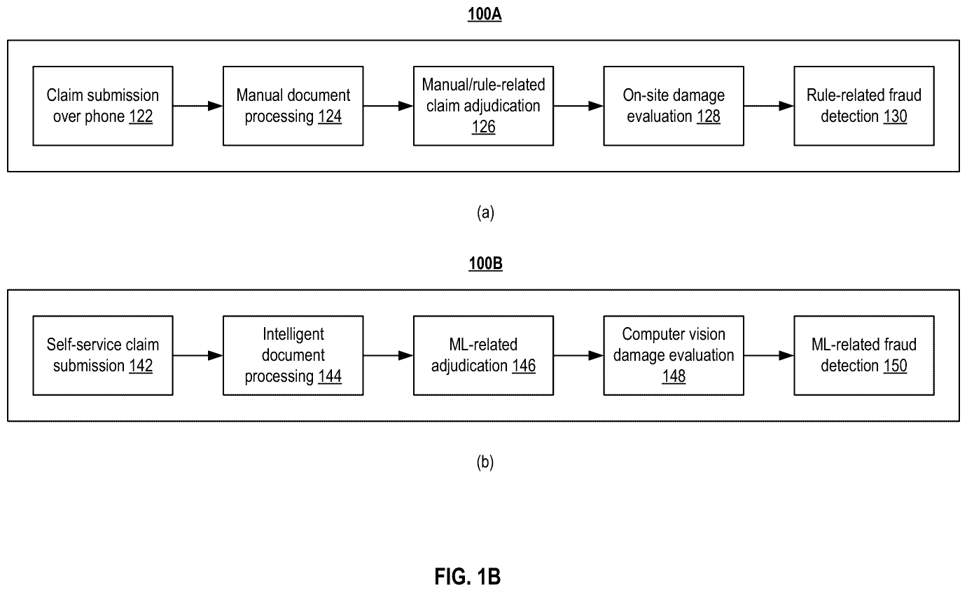

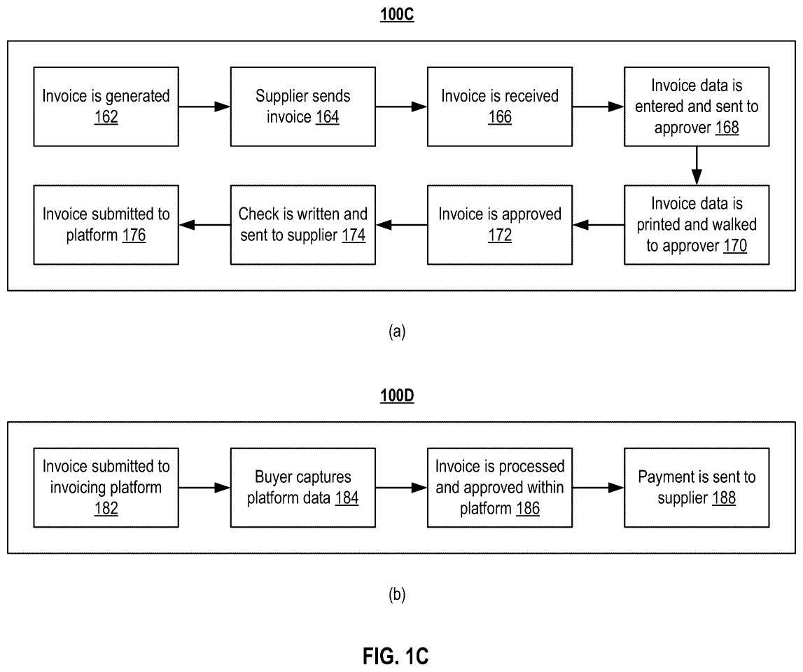

FIG. 1A illustrates an exemplary operational process or event-to-entry process 100, according to some embodiments. As illustrated, an event-to-entry process 100 may include a repeatable pattern-related sequence of events such as Event A 102a, Event B 102b, Event C 102c, . . . , Event N 102n (together or individually referred to as event 102) that together accomplish a certain objective. Each event 102 may include a specific procedure to achieve certain function(s) that is the same or different from other events included in the process. The various events when performed according to a predefined sequence may allow achieving the objective of the event-to-entry process 100.

In real applications, any number of events 102 can be included in an event-to-entry process 100. For example, the number of events included in an event-to-entry process can be 1, 5, 10, 50, 100, 500, 1000, or any other possible number, depending on the complexity of the process 100. In addition, events 102 included in an event-to-entry process 100 may have a predefined sequence, which means that one event is expected to happen only until after another event completes. In some embodiments, events 102 included in an event-to-entry process 100 may not have a predefined order but rather can happen simultaneously or in different sequences. For example, Event A can happen before, at the same time, or after Event B without affecting the overall progress of an event-to-entry process 100.

In some embodiments, an event-to-entry process 100 may include one or more “event-to-entry cycles” with defined triggers as events and defined outcomes as entries across various permutations. For instance, in the accounting universe, a business activity may start with a business event and end with a recording of the business event to complete an event-to-entry cycle. For example, if a customer buys an iPad®, it becomes a business event for Apple® company because the customer bought a device from the company. The sales for the company generally get recorded in the “book” (recording utilities or devices) of Apple immediately or at a later time, e.g., end of the day, a few days later, or end of the month depending on the complexity of the purchased product. For simple products likely iPad, it may be recorded immediately, while for complex products such as certain chat engines, it may be recorded one month or two months later.

In some embodiments, an event-to-entry process 100 may include multiple event-to-entry cycles with each cycle being independent of one another and having its specific goal and function. Accordingly, in some embodiments, an event-to-entry process 100 may include a first event-to-entry cycle that includes Event A-Event D, a second event-to-entry cycle that includes Event E-Event K, and a third event-to-entry cycle that includes Event L-Event N, and so on. The exact number of event-to-entry cycles in an event-to-entry process 100 may vary and can be as large as many thousands and as small as only one cycle. In one example, the accounting universe is generally considered as consisting of n number of transactions that are essentially getting triggered by an event and culminating in an entry that gets recorded in the “book of works” (e.g., information recording utility/device/instrument). While the transactions get recorded using a plethora of systems and often pass through different systems before settling down, broadly these systems can be categorized into three categories: Systems of Record (SOR), Systems of Engagement (SOE), and Systems of Orchestration (SOO). Accordingly, in one possible scenario, an event-to-entry process 100 in the accounting universe may include three event-to-entry cycles that each handle one segment of the process, e.g., activities in one of three systems.

It is to be noted that while the later discussion is focused on an event-to-entry process 100, the disclosed concepts and principles may be similarly applied to an event-to-entry cycle. For example, a zero-touch potential can be also determined for each event-to-entry cycle included in a process.

In some embodiments, an event 102 included in an event-to-entry process 100 may be a touchpoint as illustrated in FIG. 1, which indicates that human intervention (such as input data, print a document, send a file, sign a form, etc.) is necessary for an event to complete. For example, some or all of the Event A-Event N may require human intervention and thus may be a touchpoint 104a . . . 104n (together or individually referred to as touchpoint 104) during an event-to-entry process 100. In real applications, due to the continuous advancement of the automation technologies that consistently release the human burden from certain processes, touchpoints included in an event-to-entry process may become less and less if an organization becomes aware of the advancement of the automation technologies and quickly adapts the advanced automation technologies. In an ideal situation, there is no requirement for human intervention and thus there is no touchpoint during an event-to-entry process 100, which is also referred to as a real zero-touch process or a process with real zero-touch potential. A variety of example event-to-entry processes 100 with different levels of human intervention are further described below in FIGS. 1B-1C.

FIG. 1B illustrates two exemplary event-to-entry processes with different levels of human intervention, according to some embodiments. The two processes both relate to claim processing for insurance companies or other similar industries. In a traditional claiming process 100A illustrated in Part (a) of FIG. 1B, a claim may be initiated over the phone (“event 122”) by a client. The claim-related information may be recorded by voice recording and/or user input (“event 124”). Claim adjudication is then conducted manually based on the recorded information and/or based on certain rules and/or policies governing the adjudication (“event 126”). An on-site evaluation is then conducted to confirm the claim information and/or collect additional information if necessary (“event 128”). Rule-related fraud detection is then performed according to the standard practices in the industry (“event 130”). As can be seen, the whole process 100A requires intensive human interventions in each step or each event.

Part (b) of FIG. 1B illustrates an automated claiming process 100B, which starts with self-service claim submission (“event 142”), which may include document submission or other information input by a client online, through messaging, through a mobile application, or on other platforms. Next, intelligent document processing may be automatically conducted (“event 144”), which may include automatic object identification and/or car damage diagnosis (e.g., damaged parts of a car from a card accident). Afterward, a machine learning-based adjudication is then performed (“event 146”), which employs a well-trained model to perform the adjudication without requiring human intervention. During the damage evaluation process, computer vision technology may be used instead of human intervention (“event 148”). During the fraud detection, another machine learning model is used again (“event 150”), instead of rule-based fraud detection by a human. As can be seen, most events in the process 100B get rid of human intervention by implementing certain automation technologies, such as image processing and machine learning-based classification.

FIG. 1C illustrates two other exemplary event-to-entry processes 100C and 100D with different levels of human intervention, according to some embodiments. The two processes both relate to invoice processing. In a fully “analog” accounts-payable process 100C illustrated in Part (a), an invoice is first generated (“event 162”) and sent by a supplier (“event 164”). The invoice is then received by the buyer (“event 166”). Afterward, data related to the invoice, including data not occurred in the invoice (e.g., an approval form, transaction information, etc.) is entered (“event 168”) and/or sent to the approver (e.g., by sharing the invoice data with approver) in the buyer side. The invoice/invoice data is then printed and walked to the approver (“event 170”). The approver may approve the invoice after reviewing the invoice data (“event 172”). A check is then written on the buyer side and sent to the supplier (“event 174”). The invoice is then cleared and submitted to a platform for records on the supplier side (“event 176”). For example, a hard copy is stored in the file cabinet or a scanned copy is achieved and the hard copy is shredded. As can be seen, a lack of interoperability between these events, inefficient execution (that requires human interventions), and largely analog processes create a process 100C that can take 30 to 90 days.

Part (b) of FIG. 1C illustrates an automated accounts-payable process 100D, in which an invoice can be directly submitted to an invoicing platform (“event 182”), where a buyer can capture platform data (“event 184”). Then the invoice is processed and approved, all within the platform (“event 186”), and payment goes out to the supplier (“event 188”). The benefits from this process 100D are quite clear, as automation can cut costs and human intervention and improve efficiency by a large percentage.

From the above exemplary event-to-entry processes with different levels of human intervention, it can be seen that reducing human intervention can greatly reduce cost and improve the efficiency of an operational process. In addition, by incorporating automation technologies, an event-to-entry process may have reduced exceptions and improved visibility and audit ability. For example, automated invoice tools allow for improved exception management, since data can be readily reviewed faster. The improved accuracy means fewer rejections and fewer time-resolving payment issues. In addition, being able to spot inconsistencies and trends as well as forecasting future business decisions are invaluable capabilities to any organization. E-invoicing also allows organizations to get a bird's-eye view of their spending through consolidated reporting and analytics in real-time.

The advantages of improved automation and reduced human intervention become even more obvious in view of the ongoing COVID-19 pandemic, in which “touch” is taboo during the crisis. Accordingly, in view of the ongoing crisis, many organizations look forward to improving their automation processes during their business operations, as they may find a business loss by just waiting for things to go back to where they used to be. However, as described earlier, during the automation implementation process, when an organization tries to adapt automation technologies and move forward to reduce human intervention, they may find themselves in a situation in which they do not know where they stand in the automation era. For example, an organization may have difficulty understanding how far the organization is away from the perfect automation process in view of the currently available technologies, and/or what specific fields can be improved to reduce human intervention, as currently there is no existing tool or software application that allows an evaluation of the extent of human intervention that an organization stands during its normal operations.

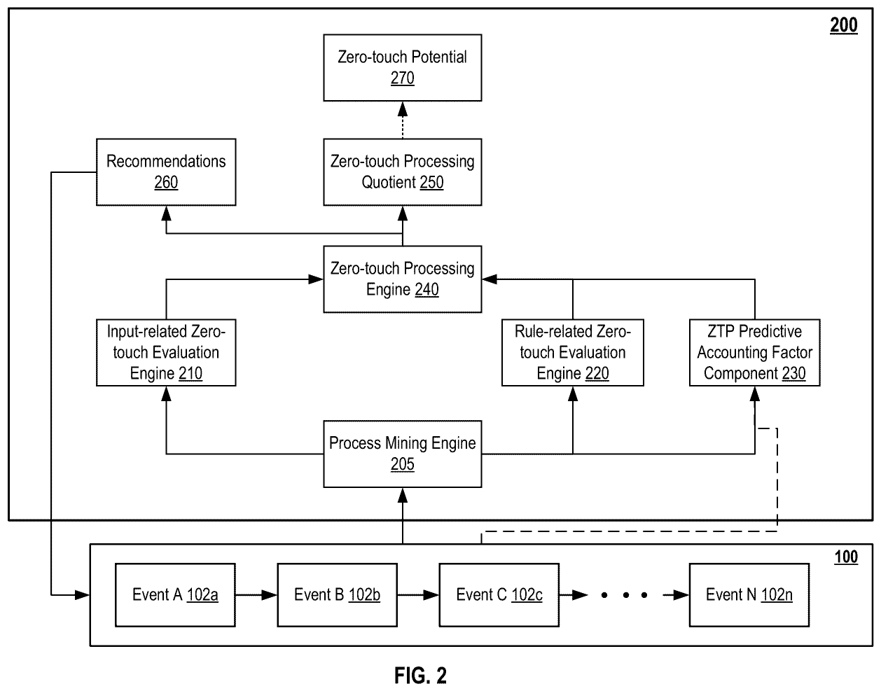

Disclosed herein is an effective tool or software application (with or without certain hardware implementations) that allows evaluating zero-touch processing quotients for an organization that aims to improve automation technologies implementation during its business operations, so as to reduce human touch or human intervention to a minimum in view of the current technologies. In some embodiments, the disclosed evaluation tool or application may also provide certain guidelines to the automation industries, e.g., provide specific guidelines for future automation technology developments. The specific functions regarding the disclosed evaluation tool or application are further described in detail with reference to FIGS. 2-8.

FIG. 2 illustrates an exemplary event-to-entry evaluation and monitoring system 200, according to some embodiments. As illustrated, the event-to-entry evaluation and monitoring system 200 may include a process mining engine 205 configured to apply specialized algorithms to system log data (e.g., event log data) to identify trends, patterns, and details of how an event-to-entry process 100 unfold, an input-related zero-touch evaluation engine 210 configured to monitor and/or optimize an event-to-entry process 100 from “input” angle-of-view, and a rule-related zero-touch evaluation engine 220 configured to monitor and/or optimize an event-to-entry process 100 from “rule” angle-of-view.

According to one embodiment, when evaluating an event-to-entry process 100 from the input angle-of-view, the input-related zero-touch evaluation engine 210 may evaluate the structuredness of data processing (especially the structure of the data used in processing), the repetitiveness of the process (e.g., how repetitive is the process), and human interventions involved in the process 100. Meanwhile, when evaluating an event-to-entry process 100 from the rule angle-of-view, the rule-related zero-touch evaluation engine 220 may evaluate standardization of the process (e.g., requiring guesswork or not), transactional/analytical activities in the process, and the extent of exceptions included in the process. In some embodiments, the input-related zero-touch evaluation engine 210 and the rule-related zero-touch evaluation engine 220 may monitor and/or optimize an event-to-entry process 100 based on the information obtained from the process mining engine 205, as illustrated in FIG. 2. In some embodiments, the input-related zero-touch evaluation engine 210 and the rule-related zero-touch evaluation engine 220 may monitor and/or optimize an event-to-entry process 100 directly from an event-to-entry process 100 without being through the process mining engine 205.

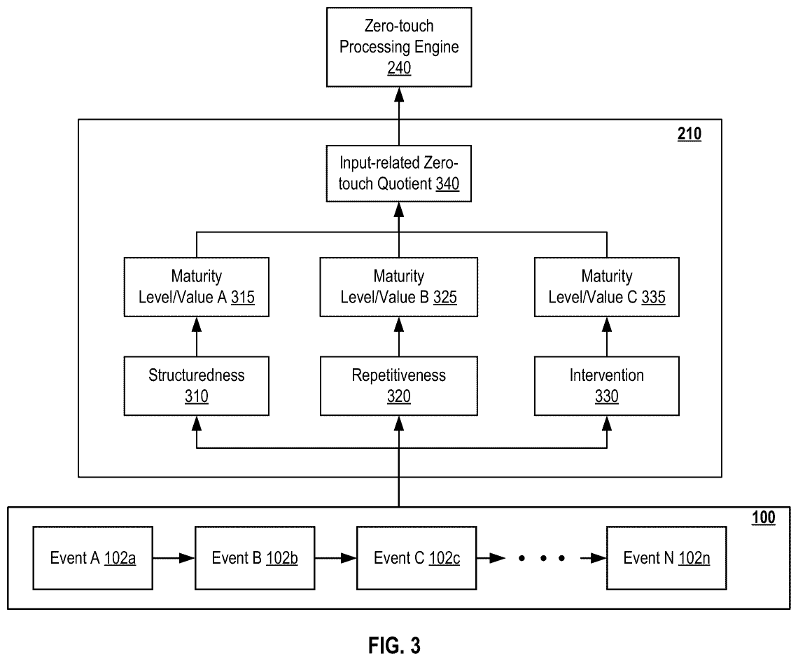

Process mining engine 205 includes logic, code, software programs, and/or associated hardware configured to apply data science to discover, validate and improve workflows of an event-to-entry process 100. By combining data mining and process analytics, the process mining engine 205 may be configured to dig into event log data from the associated information system, to read into the performance of an event-to-entry process. In some embodiments, the process mining engine 205 may leverage a data-driven approach to process optimization, allowing managers of an organization to remain objective in their decision-making around resource allocation for existing processes. In some embodiments, information system related to an organization, such as enterprise resource planning (ERP) or customer relationship management (CRM) tools, provides an audit trail of processes with their respective log data. The process mining engine 205 may be configured to utilize this data to create a process model or process graph, and use the generated process model and process graph to examine the detail and any variations associated with the process model and process graph. In some embodiments, the process mining engine 205 may leverage specialized algorithms to generate insight into the root causes of deviations from the norm, including identifying the opportunities to incorporate robotic process automation into processes and expediting any automation initiatives for an organization. More details regarding the process mining engine 205 in identifying the opportunities to improve automation are further described later in FIGS. 3-6C.

In some embodiments, when evaluating an event-to-entry process from the aforementioned different aspects, the input-related zero-touch evaluation engine 210/rule-related zero-touch evaluation engine 220 may determine a maturity level/value for each of the aforementioned aspects, where a maturity level/value for a specific aspect is evaluated by checking how far a process is from the zero-touch potential from that aspect. In some embodiments, the input-related zero-touch evaluation engine 210/rule-related zero-touch evaluation engine 220 may further determine an input-related zero-touch processing quotient/rule-related zero-touch processing quotient based on the determined maturity levels for each of the aforementioned aspects, as further described in detail in FIGS. 3-6C.

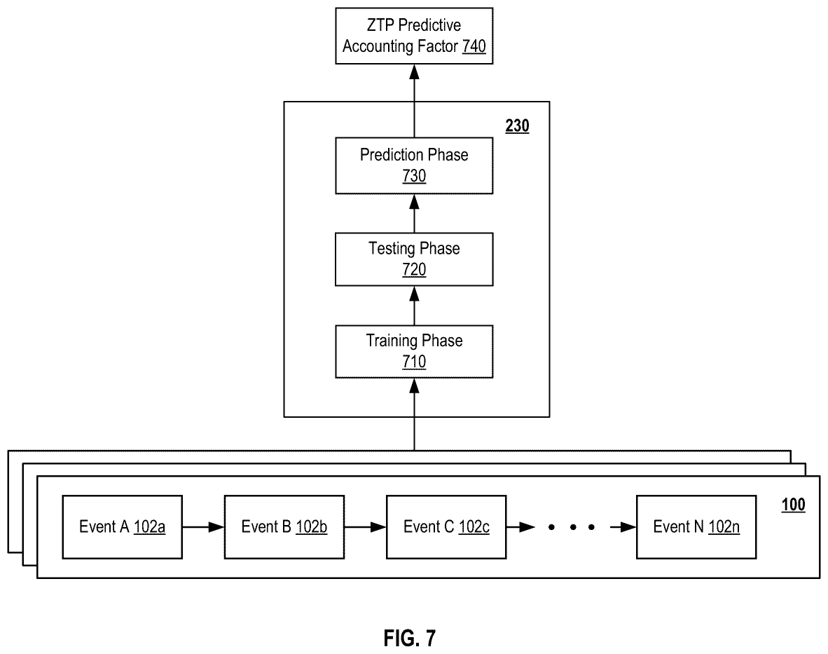

In some embodiments, the event-to-entry evaluation and monitoring system 200 may further include a zero-touch potential predictive accounting factor (ZTP PAF) component 230, as illustrated in FIG. 2. The ZTP PAF component 230 may be configured to use a machine learning model to determine how far an event-to-entry process is from reaching a zero-touch potential. In some embodiments, the ZTP PAF component 230 may also determine what improvements can be achieved to reach a real zero-touch potential that gets rid of most, if not all, human interventions in an event-to-entry process. The specific structure and functions of the ZTP PAF component 230 are further described in detail in FIG. 7.

In some embodiments, the event-to-entry evaluation and monitoring system 200 may further include a zero-touch processing engine 240 configured to evaluate the overall maturity level of an event-to-entry process based on the maturity levels evaluated from different aspects of the process. For example, the zero-touch processing engine 240 may determine a zero-touch processing quotient 250 for an event-to-entry process 100 based on the determined input-related zero-touch processing quotient, rule-related zero-touch processing quotient, and/or the ZTP PAF factor.

The zero-touch processing quotient 250 determined above may define an event-to-entry process in terms of a measurable value (e.g., an equation that includes a variety of data components, where each data component corresponds to the aforementioned different aspects of an event-to-entry process, as will be described in detail in FIGS. 3-6C). That is, for each event-to-entry process, a defined value may be determined for the extent of human intervention. For example, an event-to-entry process may currently have a value of 0.7 in the human intervention (which generally has a value of 0 to 1, with 0 meaning there is almost no human intervention). If the target is zero-touch event processing, it means there are a lot of opportunities to reduce in a way the process is being performed. In terms of a business' architecture, it then tells the business where the business is positioned regarding human intervention. Accordingly, the zero-touch processing quotient 250 determined above may provide an indication where an organization stands in terms of the extent of automation technology adaption. The higher the zero-touch processing quotient 250, the higher the extent of automation technologies that an organization has adapted. If the determined zero-touch processing quotient 250 is low for an event-to-entry process 100, it may indicate that further improvements are necessary for an organization that aims to achieve a zero-touch potential 270. At that point, the zero-touch processing engine 240 may further generate certain recommendations 260 to provide guidelines for further improvements.

The recommendations 260 may be generated based on the maturity levels determined from each aspect. For instance, if the maturity level/value determined from the structuredness aspect is low, the zero-touch processing engine 240 may generate recommendations to use more structured data in later event-to-entry processes. In some embodiments, the zero-touch processing engine 240 may even look into the data structure for specific data used in the event-to-entry process, and determine which specific data should use more structured data. In some embodiments, the zero-touch processing engine 240 may further evaluate currently available data collection and processing technologies, and recommend specific data-collection tools or technologies to be utilized to improve the data structure used in the processes. In some embodiments, the zero-touch processing engine 240 may generate recommendations from many other different aspects as well.

In some embodiments, the recommendations may be presented in a user interface for displaying the evaluation of an event-to-entry process. In some embodiments, the recommendations may further include certain links directing to specific technologies or products (e.g., most widely used technologies or products in collecting structured data) for likely improvements. Additionally, the recommendations may be automatically sent to the user accounts associated with users responsible for the automation improvements for the process 100. In some embodiments, if more advanced technologies emerge at a later time, the zero-touch processing engine 240 may generate additional recommendations and send updated recommendations again to the corresponding parties to ensure that the zero-touch potential 250 can be further improved with the advancement of automation technologies.

In some embodiments, the zero-touch processing engine 240 may calculate the zero-touch processing quotient 250 at a later time after providing certain recommendations. In cases when an organization adapts the recommended products or technologies and implements them in later event-to-entry processes 100, the recalculated zero-touch processing quotient 250 may reflect such improvements (e.g., a lower zero-touch processing quotient 250). In some embodiments, the zero-touch processing engine 240 may determine a specific time for recalculation based on the technologies or products provided in the recommendations, since different technologies may require different time lengths for implementation. In some embodiments, the zero-touch processing engine 240 may re-assess the zero-touch processing quotient 250 at a predefined frequency (e.g., every week, every month, every season, every year, etc.), even when there is no recommendation provided in the earlier reports. In one scenario, an organization may be cost-sensitive, and thus consistently look for new automation technologies for implementation, without necessarily waiting for recommendations from the zero-touch processing engine 240. Under various circumstances, when an organization consistently looks for a chance for improved automation and reduced human intervention, the organization may eventually reach its zero-touch potential 270, which means that the organization has explored all currently available automation technologies or products to minimize human intervention for a specific event-to-entry process. The specific processes for determining the zero-touch processing quotient 240 for an event-to-entry process are further described below in FIGS. 3-7.

FIG. 3 illustrates an exemplary operation of the input-related zero-touch evaluation engine 210, according to some embodiments. As described earlier, an event-to-entry process 100 can be measured from the input and rule points of view, which are applied to different segments of the process. Input is a very distinct component that tells a person what s/he is getting from others, e.g., visitor information and the like. It relates more to the substantial or factual information involved in an event-to-entry process. Rule is a part that tells what a person is supposed to do with the information. A rule can be straightforward or can be quite complex. In addition, rules can add a lot of judgments based on human insights. For instance, rules can include advice from others. In the event-to-entry evaluation and monitoring system 200 disclosed herein, by measuring the zero-touch processing quotient 250 from both the input and rule points of view, it can be ensured that more comprehensive information can be collected and evaluated for an event-to-entry process during the measurement of the zero-touch processing quotient 250.

According to one embodiment illustrated in FIG. 3, an input-related zero-touch quotient 340 can be evaluated from structuredness 310, repetitiveness 320, and intervention 330 aspects (each aspect may be also referred to as “evaluator” or “data component”). Each evaluator or data component can be measured on a spectrum of maturity levels, which may range from a trailing level to a leading level, according to one embodiment. After evaluation, each evaluator or data component may be classified into a corresponding maturity level and/or assigned a maturity value (e.g., maturity level/value A 315, maturity level/value B 325, and maturity level/value C 335) for each evaluator or data component 310-330.

As also illustrated in FIG. 3, after determining the corresponding maturity levels/values for an event-to-entry process 100 from different aspects 310-330, the input-related zero-touch evaluation engine 210 may further determine an input-related zero-touch quotient 340 for the event-to-entry process 100. The determined input-related zero-touch quotient 340 can then be used as input into the zero-touch processing engine 240 to generate the zero-touch processing quotient 250, as described earlier.

With respect to the structuredness 310, the input-related zero-touch evaluation engine 210 may measure the maturity level/value (e.g., maturity level/value A 315) of the event-to-entry process 100 based on the structure of the data set used in the process 100, e.g., whether the data set is structured or not structured. The structure is an attribute of the data set, which is determined based on how organized, formatted, and amenable to processing and analysis the data is. Unstructured data is the least formatted and structured data is the most formatted. Semi-structured data sits in between the unstructured and structured data, with the three categories existing in a continuum. Data becomes more amenable to zero-touch processing as it gets more structured. Structured data is considered more traditionally as business intelligence because it's quantifiable. It's easier to put in a database, search, and analyze. All the old-school data is in a structured form, so people can put it in the database, apply algorithms, and get value from it much quicker. Conversely, unstructured data is considered a newer type of data. It's not pre-defined and typically contains text-heavy information, such as that from social networks or customer comments. Newer types of data are more difficult to use because that data isn't in a user-friendly form.

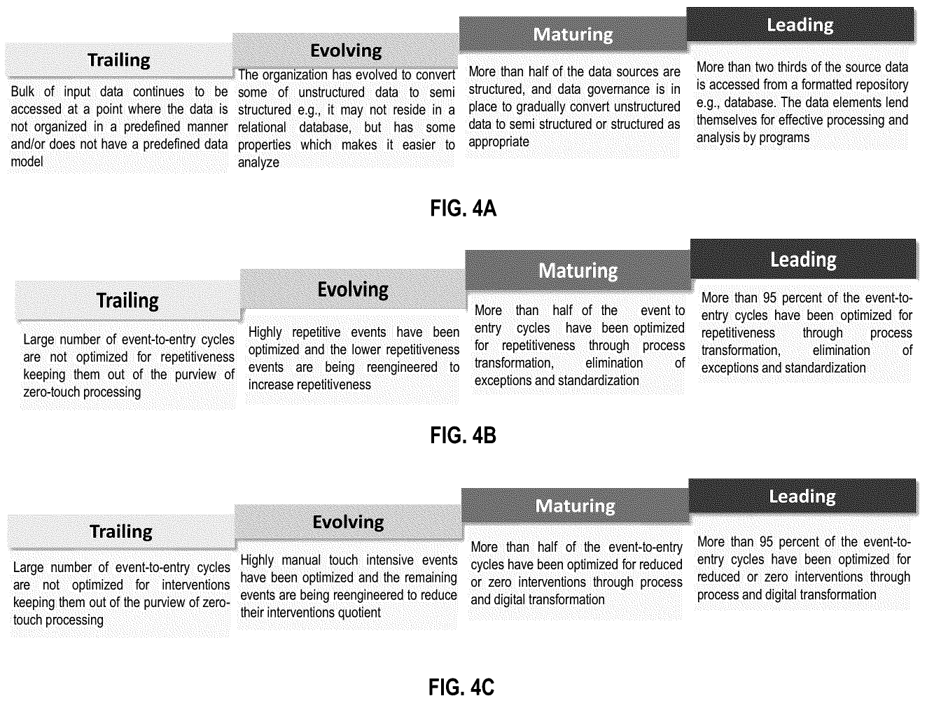

As illustrated in FIG. 4A, to measure the maturity level of an event-to-entry process 100 based on the structuredness, the input-related zero-touch evaluation engine 210 may classify the structuredness 310 of the process 100 into four different maturity levels, including trailing, evolving, maturing, and leading levels. According to one embodiment, when the structuredness 310 of an event-to-entry process 100 is classified into the trailing level, it may indicate that bulk of the source or input data continues to be accessed at a point where the data is not organized in a predefined manner and/or does not have a predefined data model. When the structuredness 310 of an event-to-entry process 100 is classified into the evolving level, it may indicate that an organization has evolved to convert some unstructured data to semi-structured data. For example, data set may not reside in a relational database, but it has some properties which make it easier to analyze. When the structuredness 310 of an event-to-entry process 100 is classified into the maturing level, it may indicate that more than half of the data sources are structured, and data governance is in place to gradually convert unstructured data to semi-structured or structured data as appropriate. When the structuredness 310 of an event-to-entry process 100 is classified into the leading level, it may indicate that more than two-thirds of the data sources are accessed from a formatted repository e.g., a database. The data elements lend themselves to effective processing and analysis by the relevant application programs.

In some embodiments, a certain maturity value may be further provided based on the structuredness evaluation of the event-to-entry process 100. For instance, if the maturity of the structuredness 310 of the process 100 falls into the trailing level, a value between 1-25 may be provided for the identified structuredness 310. Similarly, if the maturity of the structuredness 310 of the process 100 falls into the evolving level, a value between 26-50 may be provided for the identified structuredness 310, and if the maturity of the structuredness 310 of the process 100 falls into the maturing level, a value between 51-75 may be provided for the identified structuredness 310, and if the maturity of the structuredness 310 of the process 100 falls into the leading level, a value between 76-100 may be provided for the identified structuredness 310.

It is to be understood that the classification of the structuredness 310 of the process 100 into four different maturity levels and the assignment of the corresponding value ranges for these maturity levels are for interpretation purposes, and not for limitation. The maturity levels of the structuredness 310 of the process 100 may be classified into three levels, five levels, six levels, seven levels, and the like, and the corresponding value ranges may also vary (e.g., 0-10, 10-20, 20-30, 30-40, etc.). In some embodiments, the input-related zero-touch evaluation engine 210 may directly determine a maturity value regarding the maturity of the structuredness 310 of the process 100 without necessarily classifying the structuredness 310 of the process 100 into a specific maturity level.

In some embodiments, the measurement of the structuredness-related maturity level/value can be also determined by using certain predefined rules, algorithms, or using certain machine learning models trained to determine the maturity level/value of an event-to-entry process 100 from the structuredness aspect. In one example, the input-related zero-touch evaluation engine 210 may have a predefined rule or algorithm that determines the structuredness-related maturity level/value within a predefined range (e.g., 1-100) based on the information obtained from a structuredness monitor mechanism included in the process mining engine 205. The structuredness monitor mechanism may implement a process mining of the event log data to determine the structuredness in an event-to-entry process. For example, the structuredness monitor mechanism included in the process mining engine 205 may determine a percentage of data residing in a formatted repository. In some embodiments, the structuredness monitor mechanism included in the process mining engine 205 may obtain metadata information for the data used in an event-to-entry process 100 to determine the percentage of the structured data. The determined percentage of data residing in a formatted repository may then allow the input-related zero-touch evaluation engine 210 to determine a maturity value from the structuredness aspect. A higher percentage of data residing in a formatted repository, a higher maturity value for the structuredness 310 of the event-to-entry process 100. In some embodiments, the maturity value determined as above may be further adjusted based on certain other information related to the data (e.g., data accuracy). For instance, the input-related zero-touch evaluation engine 210 may adjust the assigned value based on the accuracy of the structured data. If the data has certain missing information or has certain obvious errors (e.g., certain numbers are placed into the user name information), then the assigned maturity value may be further adjusted.

In some embodiments, instead of relying on predefined rules or algorithms, the input-related zero-touch evaluation engine 210 may further include a machine learning model that is trained to automatically assign a value between 1-100 for the structuredness 310 of an event-to-entry process 100. The machine learning model may be trained using a large number of datasets with labeled values with respect to the structuredness, and thus can be used to determine a maturity value for data involved in the process 100. In some embodiments, the machine learning model may be trained to classify the data into different maturity levels without assigning a maturity value for the identified structuredness 310. A specific value within the determined maturity level may be then determined based on the predefined rules or algorithms with or without human insight. In some embodiments, additional means for determining the maturity level/value of the structuredness 310 of an event-to-entry process 100 are possible and contemplated in the disclosure.

Referring back to FIG. 3, an event-to-entry process 100 may be also measured for the maturity level (e.g., maturity level/value B 325) from the repetitiveness aspect. The repetitiveness refers to the scale of an event-to-entry process, or more specifically, the extent to which an event-to-entry process is highly repetitive or moderately repetitive, or unique. For example, bridge construction does not happen again and again in a reasonable length of period, and thus may be considered non-repetitive. On the other hand, car sales for a company can be hundreds of times a day if the sales are aggregated for the entire company in the entire country, and thus is considered highly repetitive. The repetitiveness measures a range of values that tell what process is highly repetitive, what process is moderately repetitive, and what process is rarely repetitive, or not repetitive at all. For example, an event-to-entry process 100 may be measured for the time of occurrence with a predefined time range to determine the repetitiveness of the process. In general, where there is a highly repetitive process, there is a bot to automate it. In order to achieve zero-touch processing, increasing the element of repetitiveness through multiple levers is paramount.

Referring to FIG. 4B, the maturity level of an event-to-entry process 100 can be also measured from the repetitiveness aspect 320. Similar to the above-described maturity levels classified from the structuredness aspect 310, the maturity level of the repetitiveness 320 of the process 100 can be also measured at four different levels, that is, the trailing level, the evolving level, the maturing level, and the leading level. In the embodiment illustrated in FIG. 4B, when the maturity level of the repetitiveness 320 of an event-to-entry process 100 is classified into the trailing level, it may indicate that a large number of event-to-entry cycles are not optimized for repetitiveness keeping them out of the purview of zero-touch processing. When the maturity level of the repetitiveness 320 of an event-to-entry process 100 is classified into the evolving level, it may indicate that highly repetitive processes have been optimized and the lower repetitiveness processes are being reengineered to increase the repetitiveness quotient. When the maturity level of the repetitiveness 320 of an event-to-entry process 100 is classified into the maturing level, it may indicate that more than half of the event-to-entry cycles have been optimized for repetitiveness through process transformation, elimination of exceptions, and standardization. When the maturity level of the repetitiveness 320 of an event-to-entry process 100 is classified into the leading level, it may indicate that more than 95 percent of the event-to-entry cycles have been optimized for repetitiveness through process transformation, elimination of exceptions, and standardization.

In some embodiments, the measurement of the repetitiveness-related maturity level/value can be also determined by using certain predefined rules, algorithms, or using certain machine learning models trained to determine the maturity level of an event-to-entry process 100 from the repetitiveness aspect. In one example, the input-related zero-touch evaluation engine 210 may have a predefined rule or algorithm that determines the repetitiveness-related maturity level/value within a predefined range (e.g., 1-100) based on the information obtained from a repetitiveness monitor mechanism included in the process mining engine 205. The repetitiveness monitor mechanism may implement a process mining of the event log data to determine the extent of repetitiveness in an event-to-entry process. For example, the repetitiveness monitor mechanism included in the process mining engine 205 may determine the extent of repetitiveness based on the patterns identified from multiple instances of the event-to-entry process, where the patterns for the instances may be generated based on the timelines of the included events, input/output data format, input/output data frequency, data completeness (e.g., certain cells in an excel file are missing), and the like. In some embodiments, a machine learning model may be also used to determine the maturity level/value for an event-to-entry process 100 from the repetitiveness aspect. The model may be trained using data that has been labeled with already known repetitiveness and with the marked maturity level/value. For instance, without requiring to identify patterns, a large number of event-to-entry cycles with various known degrees of repetitiveness can be input into the machine learning model to train and/or test the model. Once trained, the machine learning model can be then used to determine the repetitiveness-related maturity level and/or assign a maturity value for an event-to-entry process.

Referring back to FIG. 3, the event-to-entry process 100 may be also measured for the maturity level/value (e.g., maturity level/value C 335) from the intervention aspect. When discussing intervention in the event-to-entry cycles related to an event-to-entry process, it refers to the manual touchpoints that exist for human inputs and judgments and creates a roadblock to achieving zero-touch processing, as previously described. Taking a uber ride as an example, when a uber ride is done, oftentimes, with 1 click or zero-click, the ride gets paid depending on how the payment system is. That has very few interventions. In another example, an American insurance company pays a hospital bill, it may run 150 times of checking, validation, and verification before it can release the payment. That has a huge number of interventions because so many people are involved. So the maturity value for human intervention can be from 0 for no or little intervention to 100 with a very complex event-to-entry process that can include as many as 1000 touchpoints.

Referring to FIG. 4C, the maturity level of human intervention related to a process 100 can be also measured at four different levels. In the embodiment illustrated in FIG. 4C, when the maturity level of intervention 330 for a process 100 is classified into the trailing level, it may indicate that a large number of event-to-entry cycles are not optimized for interventions, keeping the process 100 out of the purview of zero-touch processing. When the maturity level of intervention for a process 100 is classified into the evolving level, it may indicate that highly manual touch intensive events in the process 100 have been optimized and the remaining events are being reengineered to reduce their intervention quotients. When the maturity level of intervention for a process 100 is classified into the maturing level, it may indicate that more than half of the event-to-entry cycles have been optimized for reduced or zero interventions through the process and digital transformation. When the maturity level of intervention for a process 100 is classified into the leading level, it may indicate that more than 95 percent of the event-to-entry cycles have been optimized for reduced or zero interventions through the process and digital transformation.

In some embodiments, the measurement of the intervention-related maturity level/value can be also determined by using certain predefined rules, algorithms, or using certain machine learning models trained to determine the maturity level of an event-to-entry process 100 from the intervention aspect. In one example, the input-related zero-touch evaluation engine 210 may have a predefined rule or algorithm that determines the intervention-related maturity level/value within a predefined range (e.g., 1-100) based on the information obtained from an intervention monitor mechanism included in the process mining engine 205. The intervention monitor mechanism may implement a process mining of the event log data to determine the extent of human intervention in an event-to-entry process. For example, automatic image processing for car accident evaluation may output a report in a specific format, and the metadata information regarding the report may indicate that the image is processed without human intervention. The metadata information for a report generated through human evaluation may show different information, indicating human intervention in the accident evaluation process. The intervention monitor mechanism included in the process mining engine 205 may determine the extent of human intervention based on the metadata information related to the reports included in the event log for process 100. In some embodiments, a machine learning model may be also used to determine the maturity level/value for an event-to-entry process 100 from the intervention aspect. The machine learning model may be trained based on data collected for a large number of event-to-entry processes with different levels of human interventions, where the data for these processes may have different data input/output types and data processing methods, each of which may be identified through metadata information related to the data and may be used to determine the extent of human intervention.

It is to be understood that the above-descried evaluators or data components 310-330 are not exclusive. In actual applications, there may be additional evaluators or data components that may affect the input-related evaluation of an event-to-entry process. These additional evaluators or data components may be also evaluated for maturity and assigned with certain maturity values/levels that can be applied to later zero-touch processing quotient determination. In addition, certain data components 310-330 (e.g., data advancement) described above may be not necessarily used in measuring the input-related maturity of an event-to-entry process 100.

In some embodiments, after determining the maturity values of an event-to-entry process 100 from each of the data components 310-330, a specific algorithm or function may be used to determine an input-related zero-touch quotient 340 for the process. According to one embodiment, a function for such evaluation may be denoted as a multiplier of structuredness and repetitiveness constrained by intervention (e.g., manual touchpoints), as shown in the equation below:

$$Input - related Zero - touch Quotient = i * ( \frac{Structuredness * Repetitiveness}{Intervention} )$$

The lower the value, the better quality of an event-to-entry process 100 in terms of its reduction in human intervention. The numerator has a directly proportionate and positive relationship on the process 100, while the denominator has an inverse relationship. As also illustrated in FIG. 3, the determined input-related zero-touch quotient 340 can be further used for calculating the zero-touch processing quotient 250.

As described earlier, besides the evaluation of an event-to-entry process 100 from the input point-of-view, the disclosed event-to-entry evaluation and monitoring system 200 also evaluates the process from the rule point-of-view.

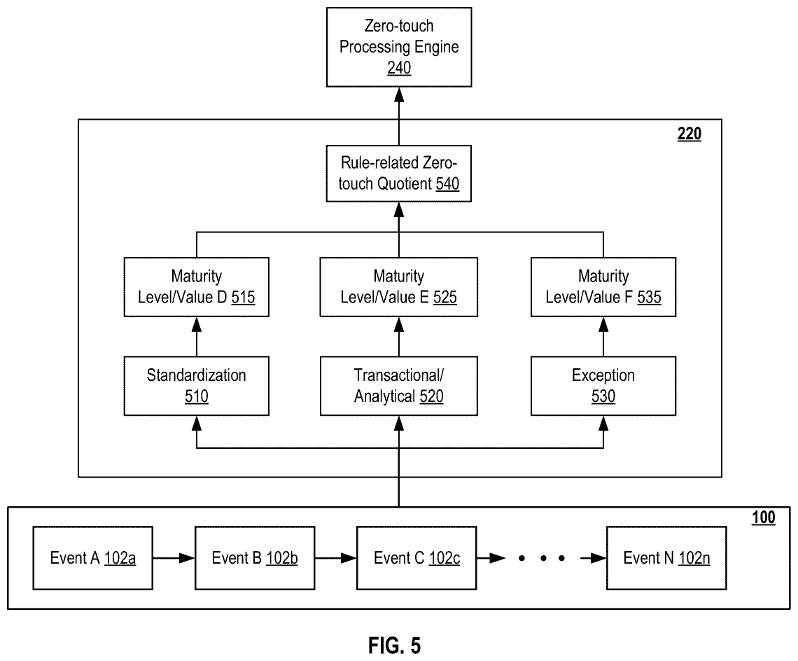

FIG. 5 illustrates an exemplary operation of a rule-related zero-touch evaluation engine 220 that measures the maturity of an event-to-entry process 100 from the rule point-of-view, according to some embodiments. Similar to the input point-of-view, when it comes to the rule point-of-view, there are certain activities that are very well defined, for example, people can be trained similarly and software used for processes can be trained so that if a person gets X s/he does Y, which becomes very standard in a way a person do it. As illustrated in FIG. 5, the maturity of an event-to-entry process 100 from the rule point-of-view can be evaluated from the standardization 510 aspect, transactional/analytical 520 aspect, and from the exception 530 aspect.

With respect to standardization 510, ideally, event-to-entry processes optimized for standardization may follow established rules that do not involve any ambiguity or guesswork. There is a standard way in which an event-to-entry process will move forward and each event-to-entry cycle follows that path without any deviation. Standardization 510 in evaluating an event-to-entry process 100 specifically measures the extent of ambiguity, guesswork, deviation, and the others that likely deviate a standard process from its expected path.

With respect to transactional/analytical 520, it refers to a way of characterizing activities (e.g., in the accounting universe) as transactional, analytical, or judgment into it. Transactional activities require minimal or zero human judgment, while decision-making analytical processes or other activities may require a high level of human judgment. For example, something very straightforward like the price for a product being sold in Walmart does not require much judgment. A person just sees the price. But there may be cases where human judgment is involved. For example, in an auction, to determine at what price the auction is to place, a person needs to evaluate a lot of things from different aspects before making a decision. In another example, if a person goes on a business trip, and the travel may need to book to some other parts of an organization. The person sends the bill to other parts of the organization, and they look into it and decide to pay 15% of the expense. Things like this are not transactional but rather analytical and every human judged. In general, transactional events or processes usually involve fast and efficient processing of routine repetitive data flows. Analytical events or processes often involve additional complex steps such as data mining and decision support. Transactional events or processes are highly amenable to zero-touch processing, while analytical events or processes need to be coupled with certain predictive models to increase the zero-touch processing quotient.

With respect to exception 530, when there are standard events, there are also events where rules do not apply, and these are exceptions to the main rules. Depending on what kind of process, there can be five exceptions and there can be a hundred exceptions in a process. Taking separate charges for a bill as an example, certain medicines are excluded and there can be different limits. Each exception is important here because it has to touch and thus increases the complexity as an event-to-entry cycle is moving to zero. In general, every exception that occurs to an event-to-entry process 100 creates a clone with some variations and puts it out of the zero-touch processing ecosystem. Regardless of what an exception is, it acts as an impediment, and a higher exception quotient in an event-to-entry process reduces the zero-touch processing.

In some embodiments, the standardization 510, transactional/analytical 520, and exception 530 can be also evaluated or measured using the above-described maturity level scheme. For example, certain maturity levels/values (e.g., maturity level/value D 515, maturity level/value E 525, and maturity level/value F 535) can be also measured for an event-to-entry process 100 from the standardization 510, transactional/analytical 520, and exception 530 aspects. The measured maturity levels/values may be then used to generate a rule-related zero-touch processing quotient 540 for the event-to-input process. In some embodiments, the rule-related zero-touch processing quotient 540 may be further input into the zero-touch processing engine 240 for generating the zero-touch processing quotient 250 and/or certain recommendations 260 as described earlier.

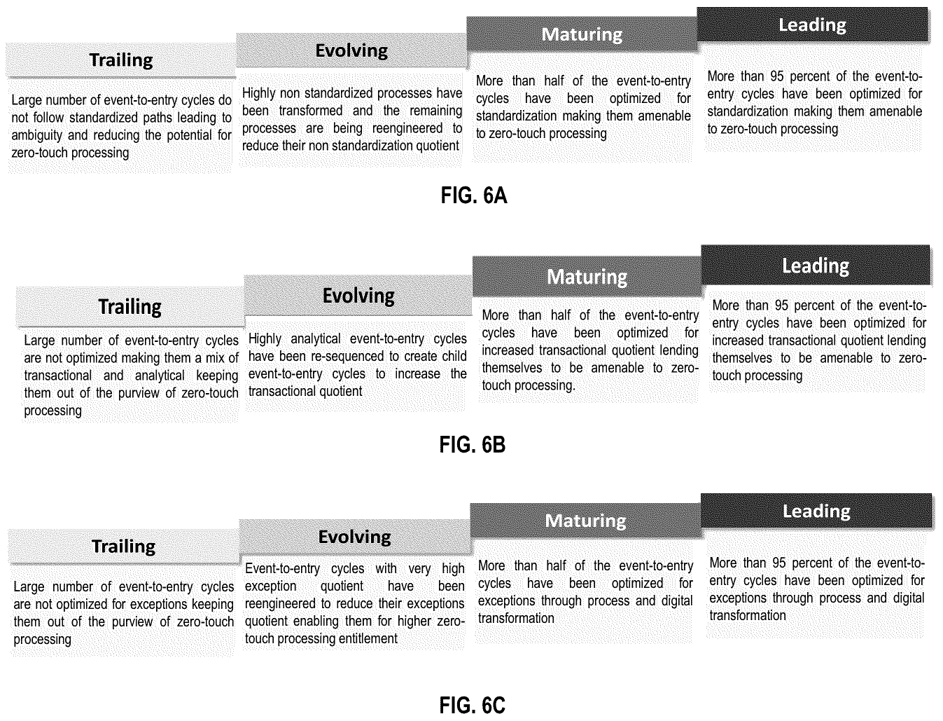

Referring to FIG. 6A, the rule-related maturity level for an event-to-entry 100 may be first measured from the standardization aspect. In the embodiment illustrated in FIG. 6A, when the standardization 510 of a process 100 is classified into the trailing level, it may indicate that a large number of event-to-entry cycles in a process 100 do not follow standardized paths, leading to ambiguity and reducing the potential for zero-touch processing. When the standardization of a process 100 is classified into the evolving level, it may indicate that highly non-standardized events in the process have been transformed and the remaining events are being reengineered to reduce their non-standardization quotients. When the standardization of a process 100 is classified into the maturing level, it may indicate that more than half of the events in a process 100 have been optimized for standardization, making them amenable to zero-touch processing. When the standardization of a process 100 is classified into the leading level, it may indicate that more than 95 percent of the events in a process 100 have been optimized for standardization making them amenable to zero-touch processing.

In some embodiments, the measurement of the standardization-related maturity level/value can be also determined by using certain predefined rules, algorithms, or using certain machine learning models trained to determine the maturity level/value from the standardization aspect. In one example, the rule-related zero-touch evaluation engine 220 may have a predefined rule or algorithm that determines the standardization-related maturity level/value within a predefined range (e.g., 1-100) based on the information obtained from a standardization monitor mechanism included in the process mining engine 205. The standardization monitor mechanism may implement a process mining of the event log data to determine the extent of standardization in an event-to-entry process based on the measure of ambiguity, e.g., by automatically measuring the volatility of probabilities just as the degree of risk can be measured by the volatility of outcomes. In one example, a Bayesian approach may be used to determine the presence of ambiguity.

In some embodiments, a machine learning model may be also used to determine the maturity level/value for an event-to-entry process 100 from the standardization aspect. The machine learning model may be pre-trained by using data from similar processes that have different extents of standardization included in the processes. The data may be obtained from process mining programs configured to monitor standardization (e.g., by detecting the number of transactional queries and analytical queries) for different processes. The obtained data may be further labeled to indicate the different extents of standardization in these processes, which are then used to train the machine learning model for the prediction of the maturity level/value of an event-to-entry process from the standardization aspect.

Referring to FIG. 6B, the rule-related maturity level for an event-to-entry 100 may be further measured from the transactional/analytical 520 aspect. In the embodiment illustrated in FIG. 6B, when the transactional/analytical 520 of a process 100 is classified into the trailing level, it may indicate that a large number of event-to-entry cycles are not optimized, making the cycles a mix of transactional and analytical and keeping the cycles out of the purview of zero-touch processing. When the transactional/analytical 520 of a process 100 is classified into the evolving level, it may indicate that highly analytical event-to-entry cycles have been re-sequenced to create child event-to-entry processes to increase the transactional quotient. When the transactional/analytical 520 of a process 100 is classified into the maturing level, it may indicate that more than half of the event-to-entry cycles have been optimized for increased transactional quotient, lending themselves to be amenable to zero-touch processing. When the transactional/analytical 520 of a process 100 is classified into the leading level, it may indicate that more than 95 percent of the event-to-entry cycles have been optimized for increased transactional quotient, lending themselves to be amenable to zero-touch processing.

In some embodiments, the measurement of the transactional/analytical-related maturity level/value can be also determined by using certain predefined rules, algorithms, or using certain machine learning models. In one example, the rule-related zero-touch evaluation engine 220 may have a predefined rule or algorithm that determines the transactional/analytical-related maturity level/value within a predefined range (e.g., 1-100) based on the information obtained from a transactional/analytical activity monitor mechanism included in the process mining engine 205. The transactional/analytical activity monitor mechanism may implement a process mining of the event log data related to an event-to-entry process 100 to determine the amount of transactional/analytical activity in the process, e.g., by automatically detecting the number of transactional queries (e.g., a query to complete a transaction, a query for information from a database, etc.) and analytical queries (e.g., a query asking how many customers are based on in San Francisco, etc.) received during the process. In some embodiments, a machine learning model may be also used to determine the maturity level/value for an event-to-entry process 100 from the transactional/analytical aspect. The machine learning model may be pre-trained by using data from similar processes that have different levels of transactional/analytical activities included in the processes. The data may be obtained from process mining programs configured to monitor transactional/analytical activities (e.g., by detecting the number of transactional queries and analytical queries) for different processes. The obtained data may be further labeled to indicate different levels of transactional/analytical activities in these processes, which are then used to train the machine learning model for the prediction of the maturity level/value of an event-to-entry process from the transactional/analytical aspect.

Referring to FIG. 6C, the rule-related maturity level for an event-to-entry 100 may be further measured from the exception 530 aspect. In the embodiment illustrated in FIG. 6C, when the exception 530 of a process 100 is classified into the trailing level, it may indicate that a large number of event-to-entry cycles are not optimized for exceptions, keeping them out of the purview of zero-touch processing. When the exception 530 of a process 100 is classified into the evolving level, it may indicate that event-to-entry cycles with very high exception quotients have been reengineered to reduce their exception quotients, enabling them for higher zero-touch processing entitlement. When the exception 530 of a process 100 is classified into the maturing level, it may indicate that more than half of the event-to-entry cycles have been optimized for exceptions through the process and digital transformation. When the exception 530 of a process 100 is classified into the leading level, it may indicate that more than 95 percent of the event-to-entry cycles have been optimized for exceptions through the process and digital transformation.

In some embodiments, the measurement of the exception-related maturity level/value can be also determined by using certain predefined rules, algorithms, or using certain machine learning models. In one example, the rule-related zero-touch evaluation engine 220 may have a predefined rule or algorithm that determines the exception-related maturity level/value within a predefined range (e.g., 1-100) based on the information obtained from a process exception monitor mechanism included in the process mining engine 205. The process exception monitor mechanism may implement a process mining to discover exceptions in an event-to-entry process, e.g., by automatically detecting missing data or information that are necessary to proceed in the process. In some embodiments, a machine learning model may be also used to determine the maturity level/value for an event-to-entry process 100 from the exception aspect. The machine learning model may be pre-trained by using data from similar processes that have different levels of exceptions. The data may be obtained from process mining programs configured to monitor exceptions for different processes. The obtained data may be further labeled to indicate different levels of exceptions, which are then used to train the machine learning model for the prediction of the maturity level/value of an event-to-entry process from the exception aspect.

In some embodiments, after determining the specific maturity values of an event-to-entry process 100 from the standardization, transactional/analytical, and exception aspects, a specific function may be used to evaluate the process 100 for a rule-related zero-touch quotient 540. According to one embodiment, a function for such evaluation may be denoted as a multiplier of standardization and transactional/analytical constrained by exception, as shown in the equation below:

$$Rule - related Zero - touch Quotient = r * ( \frac{Standardization * Transactional}{Exception} )$$

Here, “transactional” may refer to the maturity value for an event-to-entry process from the transactional/analytical 520 aspect. In some embodiments, the rule-related zero-touch quotient 540 can be further used to calculate the zero-touch processing quotient 250 by the zero-touch processing engine 240, as described earlier.

Referring back to FIG. 2, besides the above-described input-related zero-touch evaluation quotient 340 and the rule-related zero-touch evaluation quotient 540, another critical component for the evaluation of an event-to-entry process is the ZTP PAF. The ZTP PAF is a specific value used to indicate the extent to which a zero event-to-entry potential (also referred to as zero-touch potential) can be achieved within the given constraints of attributes. It denotes the incremental entitlement powered by the cognitive intelligence for defined segments of an event-to-entry process 100, for example, a system of record, a system of engagement, and a system of orchestration increasingly embedded or augmented with the power of artificial intelligence in the accounting universe.

Taking an event-to-entry process for a particular company in a particular industry that might use some degree of automation and some degree of human intervention, which means that currently there might be some convert entries, accounting entries and the like that can be performed immediately or at a later time depending on the complexity of these entries. To determine the ZTP PAF, system logic for the ZTP PAF component 230 may take into account that particular event-to-entry sequence of events in that industry, and consider what possible automation is currently available. For example, in the accountant universe, currently available automation may include tools such as ERP and CRM tools, through which the transactions are recorded, which can be then used in additional applications in the accounting universe and in many other various applications that reduce human intervention. If the particular company uses the currently available automation technology in the market, the system logic for the ZTP PAF component can then determine to what extent that time can be reduced. Based on that, the system logic for the ZTP PAF component may assign a predictive value that tells the extent to which time can be reduced. For example, an insurance company may take 10 days to take a particular claim to be processed because it has to verify 20 things and so on. In a hypothetical example, there may be new insurance companies that basically tell the client to send images taken from different directions, through which the system can automatically decide to what extent the damage is, and how much compensation is. Nobody will visit the car to physically check the car. This is a kind of automation, which means that the client just sends the pictures and then automatically gets the compensation, instead of someone from the car insurance company physically checking the car and conducting personal evaluation and so on. In some embodiments, the function of the system logic for the ZTP PAF component is aware of and to find at what computed the probability of zero-touch processing exists. It exists or does not exist, and if it exists, at what extent the current situation is, and to what extent the zero-touch processing quotient can be reduced to reach its zero-touch potential (ZTP). For example, the system logic for the ZTP PAF component may tell that the process 100 can be reduced from 80% to 20%. Thereafter, the system logic for the ZTP PAF component may consistently evaluate the ZTP PAF value since the data including the automation technology implementation may keep changing, which will change the ZTP PAF, too.

In some embodiments, the system logic for the ZTP PAF component may also tell the entitlement to the future state vs. the current state in view of the automation technology related to an event-to-entry process. If the current state is very good, there can be zero incremental entitlement, which means that the zero-touch potential is zero or the current zero-touch processing quotient 250 for the process can be reduced to zero. On the other hand, and if the current state is very bad, there can be a large number of incremental entitlements, which means that the zero-touch potential can't be zero at this moment in view of the currently available automation technologies, and it will need additional efforts in the automation technology to further reduce the zero-touch potential for the process.

In some embodiments, to determine the ZTP PAF value for a specific process, the system logic for the ZTP PAF component 230 may employ machine learning models or other artificial intelligence technologies. For instance, the ZTP PAF component can derive the ZTP PAF value by running simulations on thousands of event-to-entry processes (or event-to-entry cycles) for various permutations of event-to-entry process attributes, as further described below in FIG. 7.

Specifically, to put the ZTP PAF into consideration in evaluating an event-to-entry process 100, the relationship between the above-described data components can be identified through the study of thousands of data-to-entry processes 100 (or event-to-entry cycles) in real-world scenarios augmented by a machine learning model. In general, the training dataset contains a large number (e.g., hundreds, thousands, tens of thousands, etc.) of values/features/attributes of data-to-entry processes (or event-to-entry cycles). This training dataset is applied to a machine learning process to generate learning values also known as prediction values. The training of the machine learning model begins with the creation of a training dataset and a test dataset. To create a training dataset, data-to-entry processes (or event-to-entry cycles) are analyzed by humans and labeled. This generally entails performing the action the machine learning module is expected to perform. Such labeled data is then divided into two sets, called a training dataset and a test dataset.

During the training phase 710, the data-to-entry processes 100 (or event-to-entry cycles) training dataset is supplied to the machine learning model, and outputs from that model are then obtained. These outputs are compared against the labeled outputs, and error signals are identified if the model outputs and labeled outputs are different. The error signals may be then provided to the model in training. In response, the model may perform the necessary adjustments (e.g., through adjusting certain weights). The training process is repeated, and a new set of error signals may be obtained if there are any. The same set of supplied inputs may be used for training again, because the model outputs may be different due to the adjustments that have been made. The above process is iterated for a specified number of iterations or until the numbers and/or size of the errors fall below a specified threshold. At that point, the module is assumed to be trained sufficiently to move to the testing phase.

In the testing phase 720, a similar process as above is performed where inputs from the test dataset are provided to the model trained in the training phase 710. Until this moment, the model has not processed inputs corresponding to the test dataset. The model's outputs are compared with the labeled outputs corresponding to the test dataset. If the errors or the differences between the model outputs and labeled outputs are small in number and/or size, or fall below a specified threshold, the model is determined to be fully trained. Otherwise, the model is retrained. In some embodiments, the machine learning models used for determining the aforementioned maturity levels/values may be similarly trained and tested before being applied to determine the maturity levels/values.

Once the model is fully trained, the model may be moved to the prediction phase 730, during which the model can be used to determine the ZTP PAF for an event-to-entry process, that is, to determine the extent to which a zero event-to-entry process (or zero-touch potential) can be achieved within the given constraints of attributes (e.g., given automation technology among others).

The determined ZTP PAF value may be then input into an equation shown below for an evaluation of the zero-touch processing quotient 250 for an event-to-entry process 100:

$$Zero - touch Processing Quotient = {\sum }_{X - Event}^{Entry} \{ i ( \frac{Structuredness * Repetitiveness}{Intervention} ) + r ( \frac{Standardization * Transactional}{Exception} ) \} * PAF$$

The determined zero-touch processing quotient 250 may give an entitlement to how close to zero of human intervention (e.g., 10%, 20%, 30%, 40%, etc.) in an event-to-entry process 100. The closer to zero the zero-touch processing quotient, the less human intervention involved in an event-to-entry process 100.

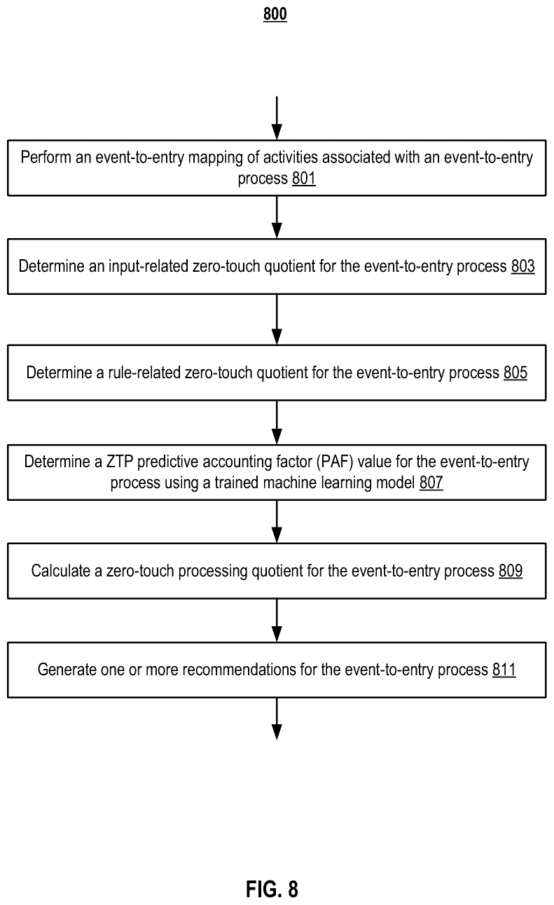

In some embodiments, the zero-touch processing quotient calculated in the above for a single event-to-entry process or single event-to-entry cycle may be referred to as “incremental zero-touch potential,” as the determined zero-touch processing quotient can be further augmented or aggregated. For instance, the zero-touch processing quotient calculated for each process or cycle may be further aggregated at the department/function levels like sales, marketing, geography and product category levels (e.g., by taking multiple insights from these different levels) or at an organization level. In some embodiments, the zero-touch processing engine 240 may include a zero-touch quotient aggregation mechanism that aggregates all event-to-entry processes or cycles included in a department or organization. The aggregated zero-touch processing quotient for a department or organization may then serve as a benchmark against peers, e.g., other departments in an organization and/or other organizations in the industry. The most effective teams and organizations will have a zero-touch potential or near zero-touch potential in terms of human intervention. The specific process for determining a zero-touch processing quotient is further described with reference to a specific application illustrated in FIG. 8.

FIG. 8 illustrates a flow chart of an exemplary method 800 for determining a zero-touch processing quotient for an event-to-entry process, according to some embodiments. Method 800 may be performed by various components included in the disclosed event-to-entry evaluation and monitoring system 200, e.g., the input-related zero-touch evaluation engine 210, the rule-related zero-touch evaluation engine 220, predictive accounting factor component 230, and zero-touch processing quotient 240. In some embodiments, method 800 may include steps 801-811. It is to be appreciated that some of the steps may be optional. Further, some of the steps may be performed simultaneously, or in a different order than that shown in FIG. 8.

Step 801: Perform an event-to-entry mapping of activities associated with an event-to-entry process with defined one or more triggers as events and defined one or more outcomes as entries.

As described earlier, an event-to-entry process may include one or more independent event-to-entry cycles, each of which may start with a triggering event and ends with an entry of an outcome of the event-to-entry cycle. In some embodiments, one even-to-entry cycle may include a sequence of events. In some embodiments, the process mining engine 205 in the disclosed event-to-entry evaluation and monitoring system 200 may perform the event-to-entry mapping to identify the events and entr(ies) associated with the event-to-entry process, for example, based on the process model(s) and process graph generated by the process mining engine 205, as described earlier.

Step 803: Determine an input-related zero-touch quotient for the event-to-entry process.

For instance, by accessing the maturity of the input-related data components associated with the event-to-entry process, the event-to-entry evaluation and monitoring system 200 may determine the maturity levels/values of the input-related data components associated with the event-to-entry process. In one embodiment, one or more machine learning models may be trained and used to determine a specific maturity value for each data component (e.g., structuredness, repetitiveness, and intervention). The determined maturity value may be between 1-100, where 1 is the lowest, and 100 is the highest in ranking. After determining the maturity value for each input-related data component, the input-related zero-touch quotient can be then calculated based on the determined maturity values.

Step 805: Determine a rule-related zero-touch quotient for the event-to-entry process.

The rule-related zero-touch quotient may be calculated similarly to the calculation of the input-related zero-touch quotient. For example, each of the rule-related data components (e.g., standardization, transactional/analytical, exception) may be assigned a value by a machine learning model. The rule-related zero-touch quotient is then calculated based on the values assigned to the rule-related data components.

Step 807: Determine a ZTP PAF value for the event-to-entry process using a trained machine learning model.

The ZTP PAF value may denote the incremental entitlement powered by cognitive intelligence for a variety of processes. According to one embodiment, the ZTP PAF value may be determined by a machine learning model that is trained based on running simulations on thousands of data-to-entry processes (or event-to-entry cycles) for various permutations of process attributes. As described earlier, the determined ZTP PAF value may indicate an extent to which zero data-to-action can be achieved within the given constraints of the attributes associated with the event-to-entry process.

Step 809: Calculate a zero-touch processing quotient for the event-to-entry process.

In some embodiments, the zero-touch processing quotient may be calculated based on the determined input-related zero-touch quotient, the rule-related zero-touch quotient and the ZTP PAF value. In some embodiments, the zero-touch processing quotient may be generated at a department level or organization level by aggregating the zero-touch processing quotients for all event-to-entry processes or event-to-entry cycles included in the department or organization.

Step 811: Generate one or more recommendations for the event-to-entry process.

As previously described, a journey to zero-touch processing for an event-to-entry process can be also monitored and accounted for through a feedback mechanism. For instance, one or more recommendations may be generated for the event-to-entry process based on the determined zero-touch processing quotient and/or specific maturity values for each data component described earlier. The adaption of the recommendations by the organization may augment the zero-touch processing quotient for the event-to-entry process, to allow the event-to-entry process to continuously improve and eventually reach its zero-touch potential, in which there is no further reduction of human intervention in the event-to-entry process in view of the constraints of the current automation technologies.

In some embodiments, the zero-touch potential for an event-to-entry process may be a dynamic value that constantly changes with the advancement of automation technologies. In this way, the event-to-entry process can be continuously improved and eventually reaches its real zero-touch potential, which means that there is no (or minimal) human intervention in the process.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Certain embodiments are described herein as including logic or a number of components, modules, engines, or mechanisms (all of which can be referred to as modules in later descriptions), for example, as illustrated and described in the figures above. Modules may constitute either software modules (e.g., code embodied on a machine-readable medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field-programmable gate array (FPGA) or an application-specific integrated circuit (ASIC)) to perform certain operations. A hardware module may also include programmable logic or circuitry (e.g., as encompassed within a general-purpose processor or other programmable processors) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

The one or more processors may also operate to support performance of the relevant operations in a “cloud computing” environment or as a “software as a service”“ (SaaS). For example, at least some of the operations may be performed by a group of computers (as examples of machines including processors), these operations being accessible via a network (e.g., the Internet) and via one or more appropriate interfaces (e.g., application program interfaces (APis).)

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that includes a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” is employed to describe elements and components of the embodiments herein. This is done merely for convenience and to give a general sense of the claimed invention. This description should be read to include one or at least one and the singular also includes the plural unless it is obvious that it is meant otherwise.

Upon reading this disclosure, those of skill in the art will appreciate still additional alternative structural and functional designs for the system described above. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A system for driving zero-touch potential for an event-to-entry process, comprising:
a processor; and
a memory, coupled to the processor, configured to store executable instructions that, when executed by the processor, cause the processor to:
perform, by a process-mining engine, process-mining on an event-to-entry process associated with an organization to collect data information associated with the process;
determine, by an input-related zero-touch evaluation engine, an input-related zero-touch quotient for the event-to-entry process based on the data information;
determine, by a rule-related zero-touch evaluation engine, a rule-related zero-touch quotient for the event-to-entry process based on the data information;
determine, by a predictive accounting factor component, a zero-touch potential predictive accounting factor (ZTP PAF) value for the event-to-entry process, the ZTP PAF value quantifying an incremental zero-touch potential for the event-to-entry process and corresponding attributes; and
generate, by a zero-touch processing engine a zero-touch processing quotient for the event-to-entry process based on the input-related zero-touch quotient, the rule-related zero-touch quotient, and the ZTP PAF value.

2. The system of claim 1, wherein, to perform the process-mining on an event-to-entry process associated with an organization, the instructions when executed by the processor further cause the processor to:
map activities associated with the organization to one or more events and one or more entries associated with the event-to-entry process.

3. The system of claim 1, wherein, to determine the input-related zero-touch quotient for the event-to-entry process, the instructions when executed by the processor further cause the processor to:
determine a first set of data components included in the event-to-entry process;
allocate a maturity value for each of the first set of data components; and
determine the input-related zero-touch quotient for the event-to-entry process based on the maturity value for each of the first set of data components.

4. The system of claim 3, wherein the maturity value for each of the first set of data components is determined by using a machine learning model.

5. The system of claim 3, wherein the first set of data components comprise one or more of a structuredness, repetitiveness, or intervention associated with the event-to-entry process.

6. The system of claim 5, wherein a maturity value of the structuredness, or repetitiveness has a proportionate and positive relationship to the input-related zero-touch quotient, and a maturity value of the intervention has an inverse relationship to the input-related zero-touch quotient.

7. The system of claim 3, wherein the instructions when executed by the processor further cause the processor to determine a maturity level for each of the first set of data components.

8. The system of claim 7, wherein the maturity level is one of a trailing level, evolving level, maturing level, or leading level.

9. The system of claim 1, wherein, to determine the rule-related zero-touch quotient for the event-to-entry process, the instructions when executed by the processor further cause the processor to:
determine a second set of data components included in the event-to-entry process;
allocate a maturity value for each of the second set of data components; and
determine the rule-related zero-touch quotient for the event-to-entry process based on the maturity value for each of the second set of data components.

10. The system of claim 9, wherein the second set of data components comprise one or more of a standardization, transactional/analytical, or exception associated with the event-to-entry process.

11. The system of claim 10, wherein a maturity value of the standardization or transactional/analytical has a proportionate and positive relationship to the rule-related zero-touch quotient, and a maturity value of the exception has an inverse relationship to the rule-related zero-touch quotient.

12. The system of claim 1, wherein the ZTP PAF value is determined by using a predictive machine learning model.

13. The system of claim 12, wherein the predictive machine learning model has been trained and tested over data including a plurality of event-to-entry processes with varying degrees of attributes.

14. The system of claim 1, wherein the instructions when executed by the processor further cause the processor to:
determine a plurality of zero-touch processing quotients for a plurality of processes associated with the organization; and
generate an aggregated zero-touch processing quotient based on the plurality of zero-touch processing quotients.

15. The system of claim 1, wherein the instructions when executed by the processor further cause the processor to:
generate one or more recommendations for improving the zero-touch processing quotient for the event-to-entry process.

16. A computer-implemented method for driving zero-touch potential for an event-to-entry process, the method comprising:
performing process-mining for an event-to-entry process associated with an organization to collect data information associated with the process;
determining an input-related zero-touch quotient for the event-to-entry process based on the data information;
determining a rule-related zero-touch quotient for the event-to-entry process based on the data information;
determining a zero-touch potential predictive accounting factor (ZTP PAF) value for the event-to-entry process, the ZTP PAF value quantifying an incremental zero-touch potential for the event-to-entry process and corresponding attributes; and
generating a zero-touch processing quotient for the event-to-entry process based on the input-related zero-touch quotient, the rule-related zero-touch quotient, and the ZTP PAF value.

17. The method of claim 16, wherein performing process-mining for an event-to-entry process associated with an organization further comprises:
mapping activities associated with the organization to one or more events and one or more entries associated with the event-to-entry process.

18. The method of claim 16, wherein determining the input-related zero-touch quotient for the event-to-entry process further comprises:
determining a first set of data components included in the event-to-entry process;
allocating a maturity value for each of the first set of data components; and
determining the input-related zero-touch quotient for the event-to-entry process based on the maturity value for each of the first set of data components.

19. The method of claim 16, wherein determining the rule-related zero-touch quotient for the event-to-entry process further comprises:
determining a second set of data components included in the event-to-entry process;
allocating a maturity value for each of the second set of data components; and
determining the rule-related zero-touch quotient for the event-to-entry process based on the maturity value for each of the second set of data components.

20. A computer program product for driving zero-touch potential for an event-to-entry process, the computer program product comprising a non-transitory computer-readable medium having computer-readable program code stored thereon, the computer-readable program code configured to:
perform a process-mining on an event-to-entry process associated with an organization to collect data information associated with the process;
determine an input-related zero-touch quotient for the event-to-entry process based on the data information;
determine a rule-related zero-touch quotient for the event-to-entry process based on the data information;
determine a zero-touch potential predictive accounting factor (ZTP PAF) value for the event-to-entry process, the ZTP PAF value quantifying an incremental zero-touch potential for the event-to-entry process and corresponding attributes; and
generate a zero-touch processing quotient for the event-to-entry process based on the input-related zero-touch quotient, the rule-related zero-touch quotient, and the ZTP PAF value.
